(19) United States
(12) Patent Application Publication
(10) Pub. No.: US 2020/0116042 A1
(43) Pub. Date: Apr. 16, 2020

(54) ADJUSTING DEVICE WITH AT LEAST ONE GUIDING DEVICE FOR THE ADJUSTMENT OF SEVERAL GUIDE VANES OF AN ENGINE

(71) Applicant: Rolls-Royce Deutschland Ltd & Co KG, Blankenfelde-Mahlow (DE)

(72) Inventor: Robert KOLETZKI, Berlin (DE)

(21) Appl. No.: 16/590,958

(22) Filed: Oct. 2, 2019

(30) Foreign Application Priority Data
Oct. 11, 2018 (DE) 10 2018 217 435.0

(51) Int. Cl. F01D 17/16

(52) U.S. Cl. CPC F01D 17/162; F05D 2240/12; F05D 2260/52; F05D 2260/56

(57) ABSTRACT

An adjusting device for adjusting a plurality of stator vanes of an engine includes an adjusting element, coupled to the stator vanes and mounted to be adjustable along a circumferential direction; an adjusting shaft for controlling movement of the adjusting element and a connecting element for transferring an adjusting force from the adjusting shaft to the adjusting element. The connecting element is coupled at a first end to the adjusting element and at a second end to the adjusting shaft. The connecting element is mounted to be pivotable at its first end about a first pivoting axis and/or at its second end about a second pivoting axis. A guiding device defines a guidance path along which the first pivoting axis can be displaced relative to the adjusting element or the second pivoting axis can be displaced relative to the adjusting shaft when the adjusting shaft is rotated.

This application claims priority to German Patent Application DE102018217435.0 filed Oct. 11, 2018, the entirety of which is incorporated by reference herein.

The invention relates to an adjusting device for adjusting a plurality of stator vanes of an engine.

The provision of variable stator vanes to influence the flow in accordance with the speed of rotating rotor blades in engines, e.g. turbomachines and, in particular, gas turbine engines, is a matter of common knowledge. Particularly in the case of gas turbine engines, variable stator vanes are usually employed in the region of the compressor, wherein the stator vanes can be adjusted in accordance with the compressor speed. In English technical jargon, the abbreviation “VSV” is used for the variable stator vanes.

Here, the variable stator vanes are usually part of a stator vane row and are arranged within a casing, in which the rotating rotor blades are also arranged. In this case, the individual stator vanes are in practice each mounted adjustably on the casing by means of a bearing journal. Rotatable mounting of a stator vane on a hub, e.g. that of a compressor, is usually provided within the casing. Each bearing journal is rotatably mounted on the casing in an associated bearing opening in the wall of the casing. In this arrangement, the bearing journal passes through this bearing opening along a direction of extent of the bearing journal, and therefore one end of the bearing journal is accessible on an outer side of the casing to enable the corresponding stator vane to be adjusted by rotating the bearing journal. In this case, a respective lever usually engages on one journal end, which is secured on an adjusting element in the form of an adjusting ring of an adjusting device in order to adjust a plurality of stator vanes simultaneously by adjusting the adjusting element and a plurality of levers articulated thereon. In practice, the bearing journals of the stator vanes, which are also often referred to as spindles, are provided in radially projecting sleeve-shaped bearing extensions of the casing. These bearing extensions are formed on a wall of the casing and ensure rotatable mounting and support for the bearing journals.

The at least one adjusting element of the adjusting device provided for adjustment of the stator vanes is usually supported on an outer side of the casing and is adjustable relative to the latter in the circumferential direction in order to bring about rotation of the stator vanes about the respective axis of rotation thereof. The adjusting element is coupled to a connecting element of the adjusting device, e.g. connected to the latter in an articulated manner, the connecting element, in turn, additionally being coupled to an adjusting shaft of the adjusting device. This adjusting shaft, which is usually designed as a crankshaft, is set up and provided for control of an adjusting movement of the adjusting element and, for this purpose, is rotatable about a longitudinal axis of the adjusting shaft by means of an actuator. The adjusting shaft has, for example, at least one coupling element, which is coupled to the connecting element and on which the connecting element is articulated in order to convert a rotary movement of the adjusting shaft into an adjusting movement of the adjusting element for the adjustment of the stator vanes. An adjusting device of this kind is known from EP 2 949 878 A1, for example.

Usually, the adjusting shaft in this case has a plurality of coupling elements which are spaced apart along the longitudinal axis and on each of which a connecting element for an associated adjusting element is articulated. In this way, it is possible for a plurality of adjusting elements to be adjusted synchronously by rotating the adjusting shaft and thus for stator vanes in a plurality of stator vane rows to be adjusted. Here, the position of the individual coupling elements is used to specify what adjustment path the respectively associated adjusting element coupled via a connecting element travels when the adjusting shaft is rotated through a defined rotation angle. In this context, it is also normally significant at what radial distance from the centrally extending longitudinal axis of the adjusting shaft the respective connecting element is articulated on its associated coupling element. The arrangement of the individual coupling elements and, in particular, the radial position thereof ultimately affects the possible adjustment of the stator vanes and, in particular, the degree of adjustment of the stator vanes of different stator vane rows, which must be matched to one another.

For greater individual adaptation and more flexible control of the adjustment of stator vanes of different stator vane rows, there is a proposal in EP 1 808 579 A2 to provide an additional template, which can be adjusted by means of an actuator and which is coupled to a plurality of adjusting elements in the form of adjusting rings of the adjusting device. Formed on the template is a plurality of guide slots, each of which is assigned to one adjusting ring and into which a guide element in the form of a peg or pin of the respective adjusting ring engages. Conversely, a corresponding peg or pin used for guidance can be provided on the adjustable template. By means of adjustment of the template along the central axis and the slotted guide for the individual adjusting rings on the template, an adjusting movement along the circumferential direction is imposed on the adjusting rings in accordance with an adjustment of the template along the central axis, said adjusting movement differing depending on the adjusting ring and hence the stator vane row.

In EP 1 808 579 A2, adjustment of a respective adjusting element in the form of an adjusting ring takes place independently of an adjusting shaft and of a connecting element, such as a connecting rod, coupled to said shaft. In EP 1 808 579 A2, adjustment of the adjusting elements is, on the contrary, controlled exclusively by means of the longitudinally movable template, which is therefore used as an alternative to an adjusting shaft in a corresponding adjusting device.

It is the object of the proposed solution to make available an adjusting device for adjusting a plurality of stator vanes of an engine which, using an adjusting shaft, allows a greater degree of individual adaptation in adjustment of stator vanes of a stator vane row, depending on aerodynamic conditions.

This object is achieved by means of an adjusting device according to claim 1.

In this case, a proposed adjusting device for adjusting a plurality of stator vanes of an engine has, in particular, at least one adjusting element, e.g. in the form of an adjusting ring, which is coupled to the stator vanes and is mounted in such a way as to be adjustable along a circumferential direction defined in relation to a central axis. Furthermore, an adjusting shaft is provided for control of an adjusting movement of the adjusting element. At least one connecting element of the adjusting device, e.g. in the form of a connecting rod, is used to transfer an adjusting force from the adjusting shaft to the at least one adjusting element. The at least one connecting element is coupled at a first end to the at least one adjusting element and at a second end to the adjusting shaft, more specifically in such a way that a rotary movement of the adjusting shaft around a longitudinal axis of the adjusting shaft is converted into an adjusting movement of the connecting element. This adjusting movement of the connecting element leads, in turn, to an adjusting movement of the adjusting element in the circumferential direction and thus to the adjustment of the stator vanes coupled thereto (e.g. by means of a respective adjusting lever). For the conversion of the rotary movement of the adjusting shaft into an adjusting movement of the adjusting element in the circumferential direction by means of the at least one connecting element, the connecting element is mounted in such a way as to be pivotable at a first end about a first pivoting axis and/or at the second end about a second pivoting axis. The at least one connecting element is thus articulated at its first end and/or at its second end. Fundamentally, such a configuration is already shown by EP 2 949 878 A1, for example.

Within the scope of the proposed solution, at least one guiding device is now furthermore provided, which specifies a guidance path along which the first pivoting axis can be displaced relative to the adjusting element or the second pivoting axis can be displaced relative to the adjusting shaft when the adjusting shaft is rotated. The guiding device is thus assigned either to the first end or to the second end of the at least one connecting element. However, it is of course also possible to provide two guiding devices for both ends, the first and second end, of the at least one connecting element.

Through the use of the guiding device, the proposed solution starts from the basic idea of making available at least one additional degree of freedom for the connecting element provided for transferring the adjusting force and the adjusting movement between the adjusting shaft and the adjusting element. Since one pivoting axis and hence one articulation point of the at least one connecting element is held in a manner which allows guided displacement on the first end, coupled to the adjusting element, and/or on the second end, coupled to the adjusting shaft, the adjusting characteristic of the adjusting element can be adjusted by means of the profile of the guidance path specified by the guiding device. The additionally provided guiding device thus enables variable specification of the adjusting movements of the stator vanes to be adjusted by means of the adjusting device.

Thus, the profile of the guidance path can be adapted selectively in accordance with aerodynamic, engine-specific requirements on a stator vane row. Accordingly, there is no need to make any change to the basic construction of the adjusting device together with the adjusting shaft, connecting element and adjusting element. On the contrary, in one proposed design variant it is sufficient to exchange a guiding device component that specifies the guidance path or to provide different components, each specifying the guidance path, for different stator vane rows in order to adapt the adjusting characteristic of individual stator vane rows individually by means of a common adjusting shaft. It is thus possible, within the scope of the proposed solution, for a plurality of (at least two) possible and mutually differing relative positions to be specified for a first and/or second pivoting axis of the at least one connecting element, depending on a rotation angle by which the adjusting shaft is rotated relative to an initial position about its longitudinal axis and thus depending on a rotational position of the adjusting shaft.

The at least one connecting element is coupled (at its first end) to the at least one adjusting element or (at its second end) to the adjusting shaft, e.g. by means of the at least one guiding device, thus making available coupling to the adjusting element or the adjusting shaft via the guiding device while simultaneously additionally providing displaceability of the corresponding pivoting axis.

In one design variant, the first end of the at least one connecting element is guided along the guidance path in such a way by means of the at least one guiding device that, when the adjusting shaft is rotated, the first end is adjusted with a motion component radial to the central axis. The at least one guiding device for the first end of the at least one connecting element thus allows displaceability of the first end, in particular perpendicularly to the circumferential direction, via the guidance path specified by the guiding device.

If the guiding device is assigned to the second end of the at least one connecting element, one design variant envisages that this second end is guided along the guidance path in such a way by means of the at least one guiding device that, when the adjusting shaft is rotated, the second end is adjusted with a motion component radial to the longitudinal axis of the adjusting shaft. Thus, by means of the guidance path, a motion component perpendicular to the direction of rotation of the adjusting shaft is imposed on the second end, for example.

Irrespective of the end to which the guiding device and hence the additional displaceability of the respective pivoting axis or of the respective articulation point of the connecting element is assigned, the additional displaceability along the guidance path makes it possible to achieve conversion of the rotary movement of the adjusting shaft into an adjusting movement of the adjusting element along the circumferential direction and thus of the stator vanes coupled thereto which is non-linear in relation to the rotary movement.

In one design variant, having a guiding device provided on the first end of the at least one connecting element, the first end is coupled to the adjusting element by means of, for example, a connecting part, on which part of a slotted guide of the guiding device is provided for the purpose of specifying the guidance path. Here, the connecting part can be, in particular, a part which is connected rigidly to the adjusting element, i.e. is fixed thereon or formed integrally thereon, and on which the connecting element engages in order to transfer an adjusting force from the connecting element to the adjusting element. Since part of a slotted guide of the guiding device is then provided precisely on this connecting part, displaceability of the first end on the adjusting element or of a component rigidly connected to the adjusting element is provided.

In this context, the slotted guide can fundamentally comprise a guide slot and at least one guide element, which can be moved along the guide slot. In one design variant, the guide slot is then formed on the connecting component, for example, while the guide element is provided on the first end of the at least one connecting element. Conversely too, of course, the formation of the guide element on the connecting component and the formation of the guide slot at the first end of the connecting element are also possible.

In one design variant, in which the or an additional guiding device is assigned to the second end of the at least one connecting element, the second end is coupled to the adjusting shaft by means of a coupling element connected to the adjusting shaft for conjoint rotation therewith. Part of a slotted guide of the guiding device for specifying the guidance path is provided on the coupling element. In this case, provision can be made, for example, for at least one guide slot or at least one guide element that can be moved along a guide slot to be provided on the coupling element fixed on the adjusting shaft or formed integrally thereon. Thus, one possible design variant envisages that the slotted guide comprises a (first) guide slot in the coupling element and at least one guide element, movable along the guide slot situated on the coupling-element side, on the second end of the at least one connecting element.

In a development, the slotted guide comprises two at least partially overlapping guide slots and at least one guide element, which can be moved along both guide slots. In this variant, a double slotted guide is therefore provided, and at least one guide element is therefore held movably on two guide slots. By virtue of their overlap, these two guide slots together specify the guidance path along which the guide element and the guide slots are displaced relative to one another during a rotation of the adjusting shaft. By means of the at least partially overlapping guide slots and the guide element held movably on both guide slots, it is thus possible, in the region of the second end of the connecting element and hence in the region of the rotatable adjusting shaft, for a relatively complex adjustment path to be specified for the second pivoting axis of the connecting element and thus for the second articulation point of said element.

For example, the adjusting shaft is rotatable relative to a guiding part of the guiding device in which a further (second) guide slot is provided, which at least partially overlaps the (first) guide slot of the coupling element. The guide element of the second end is then movable along the (first) guide slot of the coupling element and along the (second) guide slot of the additional guiding part. Since the coupling element is connected to the adjusting shaft for conjoint rotation therewith and the adjusting shaft is rotatable relative to the guiding part, the (first and second) guide slots of the coupling element and of the guiding part are displaced relative to one another during a rotation of the adjusting shaft. This displacement movement then imposes on the guide element, which engages in both guide slots, a predetermined guidance path, along which the second pivoting axis of the connecting element travels during a rotation of the adjusting shaft.

The guide slot of the guiding part can be formed in a section of the guiding part which extends radially outwards in relation to the longitudinal axis of the adjusting shaft, for example. It is likewise possible for the guide slot of the coupling element, which is fixed on the adjusting shaft or formed integrally with the adjusting shaft, to be formed in a section of the coupling element which extends radially in relation to the (centrally extending) longitudinal axis of the adjusting shaft.

In principle, the guiding part, relative to which the adjusting shaft can be rotated, can be fixed or integrally formed on a bearing part, e.g. a bearing pedestal, which rotatably supports the adjusting shaft. A bearing part of this kind is then fixed on an outer lateral surface of a casing in which the stator vane row to be controlled is accommodated, for example.

In principle, as already explained at the outset, at least two adjusting elements for stator vanes of two different stator vane rows can be provided and can each be coupled to an associated connecting element for transferring an adjusting force from the adjusting shaft to the respective associated adjusting element. Thus, adjusting rings for different stator vane rows are coupled to a common adjusting shaft by means of individual connecting rods, for example, thus enabling stator vanes of different stator vane rows to be adjusted by rotating the common adjusting shaft.

In the case of a guiding device having a guiding part, it is possible in this context to provide for the adjusting device to have at least two guiding parts with guide slots that differ from one another. The at least two guiding parts are then each assigned to one of the at least two connecting elements. Accordingly, in order to specify a different adjusting characteristic for the different adjusting elements by means of the respective guiding device with the same rotation angle of the common adjusting shaft, guide slots of different design and consequently guidance paths with a different profile are provided. The second ends of the at least two connecting elements, said ends each carrying a guide element, are thus guided along different guide paths during a rotation of the adjusting shaft, resulting in different adjusting movements of the adjusting elements for the different stator vane rows.

A guide slot, in particular a guide slot of a connecting part, of a coupling element and/or of a guiding part, can have an arched or curved profile, at least in one section. In particular, at least one section of a guide slot can extend along a circular arc and thus, for example, in a circular-arc or banana shape. In principle, however, any other profile, in particular any continuous and, for example, also a linear profile, can be provided, in accordance with the respective aerodynamic requirements for example.

In a design variant in which the guiding device is assigned to a second end of the at least one connecting element, the guiding device comprises a guide element which is connected to the second end and which is taken along by rotation of the adjusting shaft and, at the same time, guided along a control contour. Thus, in contrast to the design variant explained above, it is possible for no further (second) guide slot to be provided in a guide element of this design variant. In contrast, a displacement of the second pivoting axis during rotation of the adjusting shaft is controlled via the guidance of the guide element along a control contour.

For this purpose, the control contour has sections at different radial distances from the longitudinal axis of the adjusting shaft, thus enabling the guide element to be displaced radially in relation to the longitudinal axis, or ensuring that it is displaced radially in relation to the longitudinal axis during rotation of the adjusting shaft, by being guided along these sections of the control contour. Accordingly, the control contour is designed in such a way that the guide element guided thereon is displaced radially in relation to the longitudinal axis of the adjusting shaft during a rotation of the adjusting shaft in at least one section of a permissible rotary movement range of the adjusting shaft and that, at the same time, the second end, connected to the guide element, of the at least one connecting element and hence the articulation point thereof or the second pivoting axis thereof is displaced.

The control contour is formed, for example, on a control element, relative to which the adjusting shaft is rotatably mounted. A control element of this kind can be, for example, a separately manufactured component which is mounted on a bearing part on which the adjusting shaft is rotatably mounted. As an alternative, however, it is also possible for the control element to be formed integrally on a corresponding bearing part or to be fixed on a casing for the stator vanes independently of and, in particular, at a distance from a bearing part.

In one design variant, the guide element which can be guided along the control contour is elastically preloaded against the control contour by means of at least one spring element. Here, the at least one spring element can comprise a compression spring, for example. Elastic preloading of the guide element is used, for example, to ensure that one section of the guide element always rests against the control contour and that the guide element follows the control contour during a rotation of the adjusting shaft.

The guiding device can furthermore have a connector component on or in which the guide element is movably mounted and which is connected to the adjusting shaft for conjoint rotation therewith. The connector component supporting the guide element is thus co-rotated during a rotation of the adjusting shaft. Accordingly, the co-rotated connector component takes along the guide element mounted movably therein around the longitudinal axis of the adjusting shaft and, in the process, guides the guide element along the (immobile) control contour.

The connector component can furthermore also be provided to support the at least one spring element by means of which the guide element is elastically preloaded against the control contour. In this case, the second end of the at least one connecting element can then be connected to a bearing element of the guiding device, for example. The spring element is then supported, on the one hand, on this bearing element connected to the second end of the connecting element and, on the other hand, on the connector component connected to the adjusting shaft for conjoint rotation therewith.

For compact and space-saving arrangement of a guiding device formed with a bearing element and a connector component, provision can be made for the bearing element to have an accommodation space, in which the at least one spring element and at least part of the guide element and/or of the connector component are accommodated.

In the present case, more particularly, three different variants of guiding devices at first and second ends of a component are explained, either envisaging the use of at least one slotted guide or the use of at least one control contour. In principle, it is possible for an adjusting device to provide several (at least 2) such variants jointly. In this case, the adjusting device then has a plurality of connecting elements, which can each be adjusted by means of one adjusting shaft but are coupled to adjusting elements assigned to different stator vanes (different stator vane rows). First and/or second pivoting axes of these connecting elements can then be held in such a way as to be displaceable relative to the adjusting shaft and/or the respectively associated adjusting element by means of differently configured guiding devices. For a first stator vane row, for example, a first guiding device for a first end of an associated connecting element can be provided with a slotted guide, while, for a second stator vane row and the associated connecting element, a guiding device having a guide element that can be guided along a control contour is provided for a second end of this connecting element.

The appended figures illustrate, by way of example, possible design variants of the proposed solution.

In the figures:

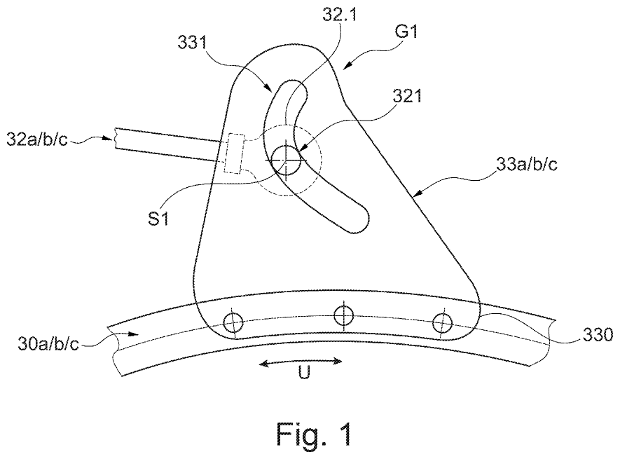

FIG. 1 shows, in a detail view and considering only a first end of a connecting element in the form of a connecting rod for a first design variant of a proposed adjusting device, a connecting part fixed in relation to the adjusting ring and designed with an arcuate guide slot, with the second end of the connecting rod articulated and movably guided thereon;

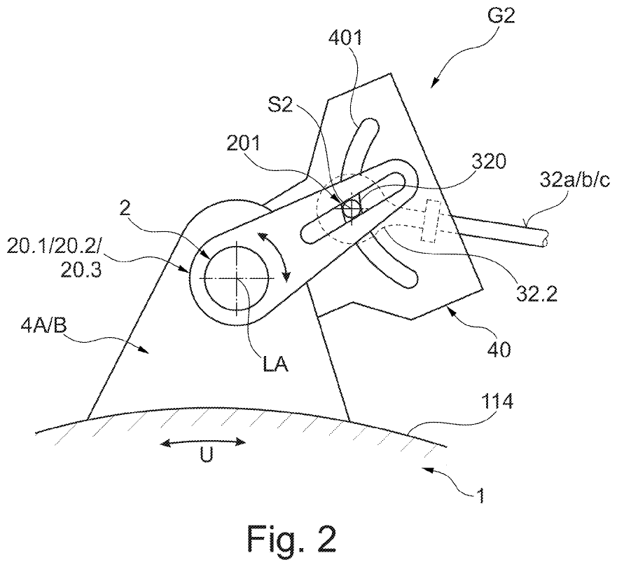

FIG. 2 shows, in a detail view, a second design variant of a proposed adjusting device having a double slotted guide at a second end of a connecting rod, wherein a guide element of the second end is held movably both in a first guide slot of a coupling element connected to an adjusting shaft for conjoint rotation therewith and in a second guide slot of an immobile guide element;

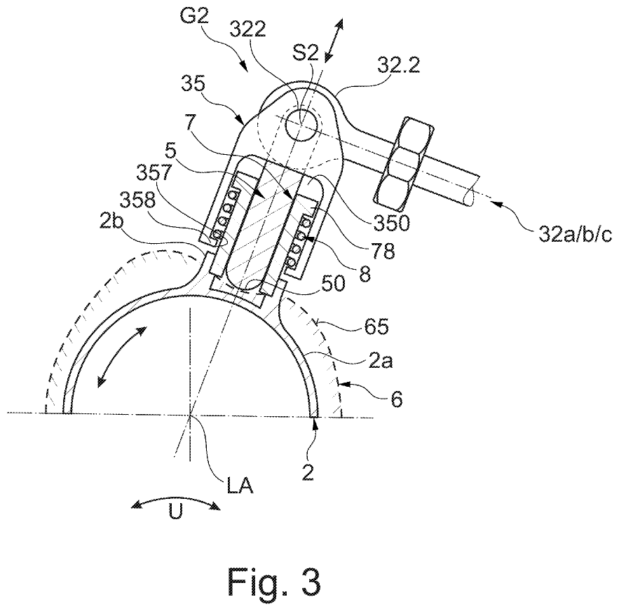

FIG. 3 shows, in a detail view, a third design variant of a proposed adjusting device, in which a guiding device at a second end of the connecting rod has, inter alia, an elastically preloaded, pin-shaped guide element which is guided along an outer control contour by rotation of an adjusting shaft in order to displace the second end of the connecting rod radially with respect to a longitudinal axis of the adjusting shaft when the adjusting shaft is rotated;

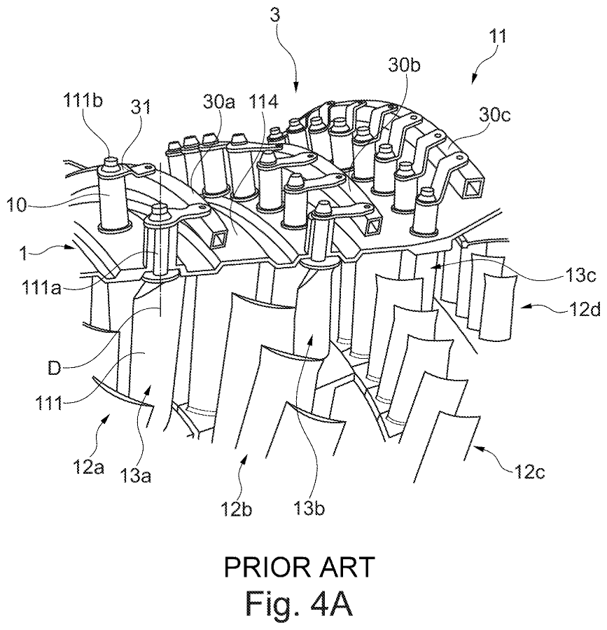

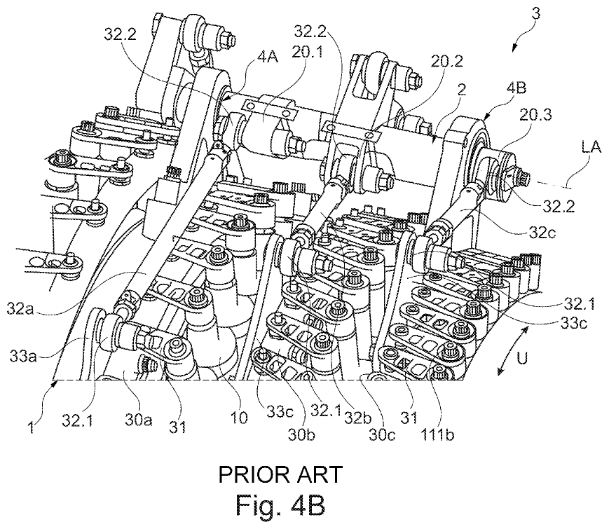

FIG. 4A shows, in a detail perspective view, an arrangement known from the prior art comprising a plurality of stator vane assemblies, each having a stator vane row and a plurality of rotor blade assemblies;

FIG. 4B shows an adjusting device, known from the prior art and based on the arrangement in FIG. 4A, for adjusting stator vanes of a plurality of stator vane rows by means of at least one rotatable adjusting shaft and a plurality of coupling elements provided thereon;

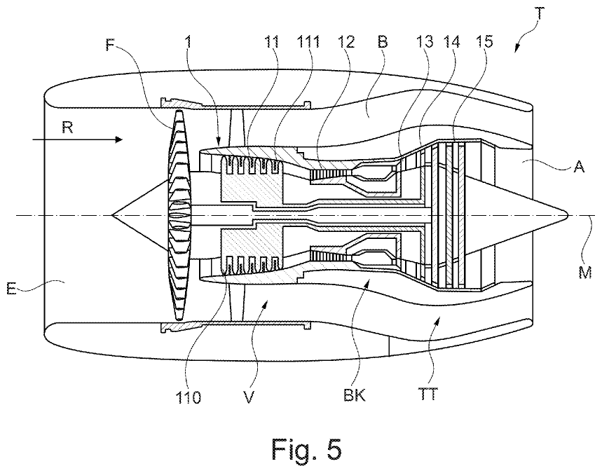

FIG. 5 shows, in a schematic sectional illustration, a gas turbine engine in which at least one proposed adjusting device is used.

FIG. 5 illustrates, schematically and in a sectional illustration, a (gas turbine) engine T, in which the individual engine components are arranged one behind the other along a central axis or axis of rotation M. At an inlet or intake E of the engine T, air is drawn in along an inlet direction E by means of a fan F. This fan F is driven via a shaft, which is set in rotation by a turbine TT. Here, the turbine TT adjoins a compressor V, which has for example a low-pressure compressor 11 and a high-pressure compressor 12, and possibly also a medium-pressure compressor. The fan F on the one hand feeds air to the compressor V and on the other hand, for generating the thrust, feeds air to a bypass duct B. The air conveyed via the compressor V ultimately passes into a combustion chamber section BK, in which the driving energy for driving the turbine TT is generated. For this purpose, the turbine TT has a high-pressure turbine 13, a medium-pressure turbine 14 and a low-pressure turbine 15. The energy released during the combustion is used by the turbine TT to drive the fan F in order then to generate the required thrust via the air conveyed into the bypass duct B. During this process, the air exits the bypass duct B in the region of an outlet A at the end of the engine T at which the exhaust gases flow outwards out of the turbine TT. In this case, the outlet A usually has a thrust nozzle.

In principle, the fan F can also be coupled to the low-pressure turbine 15, and can be driven by the latter, via a connecting shaft and an epicyclic planetary transmission. It is furthermore also possible to provide other gas turbine engines of different configurations in which the proposed solution can be used. For example, engines of this type can have an alternative number of compressors and/or turbines and/or an alternative number of connecting shafts. As an example, the engine can have a split-flow nozzle, meaning that the flow through the bypass duct B has its own nozzle, which is separate from and situated radially outside the core engine nozzle. However, this is not limiting, and any aspect of the present disclosure may also apply to engines in which the flow through the bypass channel B and the flow through the core are mixed or combined before (or upstream of) a single nozzle, which may be referred to as a mixed-flow nozzle. One or both nozzles (whether mixed flow or split flow) may have a fixed or variable region. Whilst the described example relates to a turbofan engine, the proposed solution may be applied, for example, to any type of gas turbine engine, such as an open-rotor (in which the fan stage is not surrounded by a nacelle) or turboprop engine, for example.

In the variant of an engine T which is illustrated by way of example in the present case, the compressor V comprises a plurality of rows of rotor blades 110 situated axially in series and interposed rows of stator vanes 111 in the region of the low-pressure compressor 11. The rows of rotor blades 110, which rotate around the central axis M, and the rows of stationary stator vanes 111 are arranged alternately along the central axis M and accommodated in a (compressor) casing 1 of the compressor V. The individual stator vanes 111 are mounted adjustably on the single- or multi-part casing 1—generally in addition to radially inner mounting on the hub of the compressor V.

FIG. 4A shows a segment at a greater level of detail of an arrangement known from the prior art of rotor blade rows 12a to 12d and stator vane rows 13a to 13c for the low-pressure compressor 11. The stator vanes 111 of the stator vane rows 13a, 13b and 13c arranged in series are mounted adjustably on the casing 1 in order to enable the position of the stator vanes 111 to be changed in accordance with the compressor speed and inlet gas temperature. For this purpose, a bearing journal 111a of each rotor blade 111 is mounted rotatably in a bearing opening, which is formed by a sleeve-shaped, radially outward-projecting bearing extension 10 of the casing 1. Each bearing journal 111a is mounted and supported in an associated bearing extension 10 in such a way as to be rotatable about an axis of rotation D. In this arrangement, each bearing journal 111a passes through its associated bearing extension 10, with the result that one journal end 111b projects from the bearing extension 10 on the outside of the casing 1.

It is thus possible for a respective (adjusting) lever 31 of a (stator vane) adjusting device 3 to act on the individual journal ends 111b to enable the bearing journal 111a to be rotated and thus the position of the associated stator vane 111 to be changed. In this arrangement, the levers 31 of a stator vane row 13a, 13b or 13c are each articulated on an adjusting element in the form of an adjusting ring 30a, 30b or 30c of the adjusting device 3. The adjusting ring 30a, 30b, 30c—which is often in several parts and divided into at least two segments—extends circumferentially along the outer lateral surface of the casing 1. By adjusting the adjusting ring 30a, 30b, 30c, it is thus possible to adjust the adjusting levers 31 articulated thereon and to adjust several (usually all) of the stator vanes 111 of a stator vane row 13a, 13b or 13c. Here, the individual adjusting rings 30a, 30b, 30c for the individual stator vane rows 13a, 13b and 13c are generally adjustable independently of one another. An adjusting ring 30a, 30b or 30c is supported on an outer side of the casing 1, e.g. on a circumferentially encircling contact surface 114.

FIG. 4B furthermore provides a more detailed illustration, likewise in perspective, of a segment of a prior-art adjusting device 3 for adjusting the stator vanes 111. Illustrated here in addition to individual adjusting rings 30a, 30b, 30c for the individual stator vane rows 13a, 13b, 13c is an adjusting shaft 2, here in the form of a crankshaft, for adjusting the individual adjusting rings 30a, 30b, 30c. The adjusting shaft 2 is mounted so as to be rotatable about its longitudinal axis LA on bearing pedestals 4A, 4B on an outer lateral surface of the casing 1. A plurality of coupling elements 20.1, 20.2, 20.3, each having a forked head on which a connecting element in the form of a connecting rod 32a, 32b or 32c is articulated, is furthermore provided on the adjusting shaft 2. Each connecting rod 32a, 32b and 32c is assigned to one of the adjusting rings 30a, 30b, 30c. In this case, each connecting rod 32a, 32b and 32c is articulated at a first end 32.1 on a connecting part 33a, 33b or 33c, which is fixed on the respective associated adjusting ring 30a, 30b or 30c. Via a second end 32.2, each connecting rod 32a, 32b, 32c is in each case articulated on its associated coupling element 20.1, 20.2 or 20.3 of the adjusting shaft 2. When the adjusting shaft 2 is rotated, an adjusting force is thus transferred to the individual adjusting rings 30a to 30c in order to adjust these along the circumference in a circumferential direction U and, in the process, to rotate the stator vanes 111 of the different stator vane rows 13a to 13c about the respective axis of rotation D thereof by means of the adjusting levers 31 connected to the respective adjusting ring 30a to 30c.

The extent to which the individual stator vanes 111 of the different stator vane rows 13a to 13c are adjusted when the adjusting shaft 2 is rotated and, in particular, the time at which and the extent to which the individual stator vanes 111 of a stator vane row 13a to 13c are adjusted in relation to the other stator vane rows 13a to 13c depends, in particular, on the (angular) position of the individual coupling elements 20.1, 20.2 and 20.3 relative to one another and on the radial position thereof in relation to the longitudinal axis LA of the crankshaft 2. In this case, the adjusting movement of the individual stator vanes 111, which is controllable by means of the adjusting device 3 having the adjusting shaft 2, is always linear. Consequently, a transmission ratio between a rotation angle of the actuator-adjusted adjusting shaft 2 and a rotation angle of the stator vanes 111 of a stator vane row 13a to 13c is specified on the basis of the position of the respective coupling element 20.1, 20.2 or 20.3 and is always the same, i.e. independent of a current adjustment position of the adjusting shaft 2 and thus invariable.

In this respect, the proposed solution provides a remedy. In a proposed adjusting device 3, at least one guiding device is accordingly provided in addition, said device specifying a guidance path along which
a first pivoting axis, about which a connecting rod 32a, 32b or 32c is pivotably mounted at its first end 32.1, can be displaced relative to the associated adjusting ring 30a, 30b or 30c when the adjusting shaft 2 is rotated, or
along which a second pivoting axis, about which the second end 32.2 of a connecting rod 32a, 32b or 32c is pivotably mounted, can be displaced relative to the adjusting shaft 2 when the adjusting shaft 2 is rotated.

Thus, at least one additional degree of freedom is provided for a first end 32.1 or a second end 32.2 of a connecting rod 32a, 32b or 32c to convert a rotation of the adjusting shaft 2 into a non-linear adjustment of the stator vanes 111 of a stator vane row 13a, 13b or 13c and, in particular, to tailor the adjusting movement of the stator vanes 111 to a greater extent to different aerodynamic requirements on the stator vane rows 13a to 13c.

In the design variant of which a segment is illustrated in FIG. 1, a guiding device G1 is provided for specifying a guidance path for the first end 32.1 of the connecting rod 32a, 32b or 32c. In this case, a guide element in the form of a guide pin 321, is provided, in particular formed on, the first end 32.1 of the connecting rod 32a, 32b or 32c. This guide pin 321 is held in a sliding manner in an arcuate guide slot 331 of an associated connecting part 33a, 33b or 33c. In the present case, this connecting part 33a, 33b or 33c is fixed on a longitudinal side of an associated adjusting ring 30a, 30b or 30c via a base 330. As an alternative, the connecting part 33a, 33b or 33c can be formed integrally on its adjusting ring 30a, 30b or 30c.

Together with the guide pin 321 on the connecting rod, the guide slot 331 of the connecting part 33a, 33b or 33c forms a slotted guide of the guiding device G1, by means of which a guidance path, which, in particular, extends with a component radial to the central axis M and thus perpendicularly to the circumferential direction U, is specified for the first end 32.1.

Here, the guide pin 321 of the connecting rod 32a, 32b or 32c, which is held movably at the guide slot 331 and is optionally provided with an anti-friction coating, also defines a pivoting axis S1, about which the first end 32.1 of the connecting rod 32a, 32b or 32c can be pivoted on the connecting part 33a, 33b or 33c. The guide rail 321 thus defines an articulation point of the connecting rod 32a, 32b or 32c on the connecting part 33a, 33b or 33c situated on the adjusting ring.

During a rotation of the adjusting shaft 2, in which the first end 32.1 of the connecting rod 32a, 32b or 32c is taken along around the longitudinal axis LA of the adjusting shaft 2, the guide pin 321 on the first end 32.1 of the connecting rod 32a, 32b or 32c is moved along the guide slot 331, which is curved and, in the present case, for example, is circular-arc-shaped or banana-shaped. During this process, the connecting rod 32a, 32b or 32c simultaneously takes the adjusting ring 30a, 30b or 30c along in the circumferential direction U. Owing to the fact that the first end 32.1 is guided in the guide slot 331 and, as a result, the first end 32.1 has additional displaceability, the rotation of the adjusting shaft 2 is converted in a non-linear manner into an adjustment of the associated adjusting ring 30a, 30b or 30c in the circumferential direction U. On the contrary, by virtue of the profile of the guide slot 331, the adjusting movement, resulting from a rotary movement of the adjusting shaft 2, of the adjusting ring 30a, 30b or 30c and hence of the stator vanes 111 of a stator vane row 13a, 13b or 13c, which are coupled therewith via the adjusting levers 31, is implemented with different degrees of dependence on the rotational angle of the adjusting shaft 2. In this way, the profile of the guide slot 331 can then also be matched to aerodynamic requirements on the respective stator vane row 13a, 13b and 13c. The geometry and consequently, in particular, the profile of a guide slot 331 can thus be varied for each stator vane row 13a to 13c and can therefore differ.

In the design variant in FIG. 2, a guiding device G2 for a second end 32.2 of a connecting rod 32a, 32b or 32c, having a double slotted guide, is illustrated. In this case, a coupling element 20.1, 20.2 or 20.3 connected to the adjusting shaft 2 for conjoint rotation therewith and having a guide section projecting radially outwards with respect to the longitudinal axis LA is formed. A (first) guide slot 201, which in the present case extends radially in a straight line, by way of example, is formed in this guide section.

In addition, a guiding part 40 having a further (second) guide slot 401 is provided as part of the guiding device G2. Here, the additional guiding part 40 is, for example, fixed on a bearing pedestal 4A or 4B, on which the adjusting shaft 2 is rotatably mounted. Consequently, the adjusting shaft 2 is rotatable with the respective coupling element 20.1, 20.2 or 20.3 relative to the fixed guiding part 40. During a rotation of the adjusting shaft 2 about its longitudinal axis LA, the first guide slot 201 of the respective coupling element 20.1, 20.2 or 20.3 can thus be displaced relative to the second guide slot 401, which is formed in a section of the guiding part 40 which extends radially outwards. In this case, by way of example, the second guide slot 401 of the guiding part 40 has a circular-arc-shaped or banana-shaped profile and has a concave arch in relation to the longitudinal axis LA of the adjusting shaft 2.

A guide element in the form of a guide pin 320 is provided on the second end 32.2 of the respective connecting rod 32a, 32b, 32c. In the present case, this guide pin 320 engages in both slotted guides 201 and 401 of the guiding device G2 and is held thereon in such a way as to be pivotable about a second pivoting axis S2, both on the associated coupling element 20.1, 20.2 or 20.3 and on the additional guiding part 40.

During a rotation of the adjusting shaft 2, the respective coupling element 20.1, 20.2, 20.3 takes the guide pin 320 and hence the second end 32.2 of the connecting rod 32a, 32b, 32c along by virtue of the engagement of the guide element 320 in the first guide slot 201 situated in the coupling element. However, during this process, the guide pin 320 remains movable only along the second guide slot 401 of the fixed guiding part 40, while the guide pin 320 simultaneously travels along the radially extending first guide slot 201 of the coupling element 20.1, 20.2, 20.3. By virtue of the curved, i.e. geometrically defined curvy, profile of the second guide slot 401, an adjusting movement with a movement component radial to the central axis M and consequently perpendicular to the circumferential direction U (radially inwards or radially outwards) is here imposed on the guide pin 320 and thus on the second pivoting axis S2 defined thereby. Consequently, a rotary movement of the adjusting shaft 2 is converted in a non-linear manner into an adjusting movement of the associated adjusting ring 30a, 30b or 30c and hence of the stator vanes 111 coupled thereto.

Fundamentally, the profile and hence the configuration of the second guide slot 401 in the fixed guiding part 40 can depend on aerodynamic requirements on the adjustment of the stator vanes 111 of the respective stator vane row 13a to 13c. Accordingly, second guide slots 401 of different configuration and, in particular, guiding parts 40 of different configuration can be provided, in particular for each stator vane row 13a to 13c. In one design variant, it is possible, for example, for individual guiding parts 40 for the different stator vane rows 13a to 13c to be mounted on corresponding bearing pedestals 4A, 4B or fixed in some other way in relation to the casing in order to specify different adjusting characteristics for the adjusting rings 30a to 30c via the rotation of the common adjusting shaft 2.

In the design variant of an adjusting device 3 corresponding to FIG. 3, a guiding device G2 is likewise provided for the second end 32.2 of a doubly articulated connecting rod 32a, 32b or 32c, said end being assigned to the adjusting shaft 2. In this case, the guiding device G2 of the design variant in FIG. 3 has a guide element in the form of a guide pin 5 connected to the second end 32.2 of the respective connecting rod 32a, 32b or 32c. This guide pin 5 is taken along during a rotation of the adjusting shaft 2 about its longitudinal axis LA and, during this process, is guided along a control contour 65 of a control element 6, which is stationary and fixed in relation to the casing.

On an outer lateral surface extending around the longitudinal axis LA of the adjusting shaft 2, for example, this control element 6 has the control contour 65 along which a radially inner pin end of the guide pin 5 slides by means of a contact surface 50. During this process, the guide pin 5 can be displaced by different amounts radially in relation to the longitudinal axis LA, depending on the profile of the control contour 65 of the control element 6. The displacement of the guide pin 5 in the radial direction here leads directly to a corresponding radial displacement of the articulation point of the second end 32.2 of the connecting rod 32a, 32b or 32c. For this purpose, a rotary bearing element in the form of a bearing journal 322 of the second end 32.2 is held rotatably on a radially outer pin end of the guide pin 5 or held rotatably on a casing part firmly connected thereto, for example.

In the present case, the guide pin 5 is mounted in a longitudinally movable manner in a connector component in the form of a connecting sleeve 7 of the guiding device G2. This connecting sleeve 7 is manufactured from metal, for example. In this case, the connecting sleeve 7 and the guide pin 5 are matched to one another in such a way that there is a low coefficient of friction between an inner surface of the connecting sleeve 7 and an outer surface of the guide pin 5 and therefore the guide pin 5 can slide with little friction on the inner surface of the connecting sleeve 7 owing to a radial displacement specified by the control contour 65.

On a radially inner end, at which the guide pin 5 projects from the connecting sleeve 7 by means of the contact surface 50 resting against the control contour 65, the connecting sleeve 7 has an external thread on its outer lateral surface. By means of this external thread, the connecting sleeve 7 is screwed into a socket of a driver extension 2b. This driver extension 2b is formed on a lateral surface 2a of the adjusting shaft 2, with the result that the connecting sleeve 7 screwed into the driver extension 2b is connected to the adjusting shaft 2 for conjoint rotation therewith and is taken along in rotation when the adjusting shaft 2 is rotated about its longitudinal axis LA. The co-rotated connecting sleeve 7, in turn, takes along the guide pin 5, which is held movably therein and is fixed on the second end 32.2 of the connecting rod 32a, 32b or 32c.

In order to elastically preload the guide pin 5 by means of its contact surface 50 against the control contour 65, a spring element in the form of a compression spring 8 is provided. This compression spring 8 is accommodated in an accommodation space 350 of a bearing sleeve 35 of the guiding device G2. The bearing sleeve 35 is likewise fixed on the second end 32.2 of the connecting rod 32a, 32b, 32c. In this arrangement, the guide pin 5 and the connecting sleeve 7 are arranged at least partially within the accommodation space 350.

At a radially outer end situated within the accommodation space 350, the connecting sleeve 7 forms a supporting collar 78, which lies opposite an inner supporting rim 358 of the bearing sleeve 35 in the radial direction, thus enabling the compression spring 8 to be supported on the supporting collar 78 of the connecting sleeve 7, on the one hand, and on the supporting rim 358 of the bearing sleeve 35, on the other hand. As a result, the compression spring 8 preloads the bearing sleeve 35 relative to the connecting sleeve 7 firmly connected to the adjusting shaft 2. Since the guide pin 5 is rigidly connected to the bearing sleeve 35, the guide pin 5 is in this way also preloaded against the connecting sleeve 7 and thus against the adjusting shaft 2 and the control contour 65, extending coaxially with the longitudinal axis LA of the adjusting shaft 2, of the stationary control element 6. By means of the compression spring 8, the contact surface 50 of the guide pin 5 is pressed resiliently against the control contour 65, with the result that the guide pin 5 always rests against the control contour 65 when the adjusting shaft 2 is rotated around its longitudinal axis LA.

In the design variant in FIG. 3—especially in contrast with the variant in FIG. 2—exclusively radial displaceability of one end, in this case the second end 32.2, of a connecting rod 32a, 32b or 32c in relation to the longitudinal axis LA of the adjusting shaft 2 and thus a corresponding radial displaceability of a pivoting axis S2 of the articulated connecting rod 32a, 32b or 32c is accordingly implemented. Here, the control contour 65 controlling the radial displacement of the second end 32.2, relative to which contour the adjusting shaft 2 can be rotated, depends on the aerodynamic requirements on the respective stator vane row 13a to 13c, for example. Here too, non-linear conversion of a rotary movement of the adjusting shaft 2 to an adjusting movement of an adjusting ring 30a, 30b or 30c is accordingly implemented. It is quite possible here for the profile of a control contour 65 to vary depending on the stator vane row 13a to 13c in order to bring about different adjusting movements of the adjusting rings 30a to 30c and of the stator vanes 111 coupled thereto with the same rotation angle of the adjusting shaft 2 for each stator vane row 13a to 13c.

### LIST OF REFERENCE SIGNS

1 Casing
10 Bearing extension
11 Low-pressure compressor
110 Rotor blade
111 Stator vane
111a Bearing journal
111b Journal end
114 Lateral surface
12 High-pressure compressor
12a-12d Rotor blade row
13 High-pressure turbine
13a-13c Stator vane row
14 Medium-pressure turbine
15 Low-pressure turbine
2 Adjusting shaft
20.1-20.3 Coupling element
201 Guide slot
2a Lateral surface
2b Driver extension
3 (Stator vane) adjusting device
30a, 30b, 30c Adjusting ring (adjusting element)
31 (Adjusting) lever
32a, 32b, 32c Connecting rod (connecting element)
32.1, 32.2 (Rod) end
320, 321 Guide pin (guide element)
322 Bearing journal (rotary bearing element)
330 Base
331 Guide slot
33a, 33b, 33c Connecting part
35 Bearing sleeve
350 Accommodation space
357 Opening
358 Supporting rim
40 Guiding part
401 Guide slot
4A, 4B Bearing pedestal
5 Guide pin (guide element)
50 Contact face
6 Control element
65 Control contour
7 Connecting sleeve (connector component)
78 Supporting collar (supporting section)
8 Compression spring (spring element)
A Outlet
B Bypass duct
BK Combustion chamber section
D Axis of rotation/spindle axis
E Inlet/Intake
F Fan
G1, G2 Guiding device
L Stator vane assembly
LA Longitudinal axis
M Central axis/axis of rotation
R Inlet direction
S1, S2 Pivoting axis
T Gas turbine engine
TT Turbine
U Circumferential direction
V Compressor

1. An adjusting device for adjusting a plurality of stator vanes of an engine, having
at least one adjusting element, which is coupled to the stator vanes and is mounted in such a way as to be adjustable along a circumferential direction defined in relation to a central axis,
an adjusting shaft for controlling an adjusting movement of the adjusting element and
at least one connecting element for transferring an adjusting force from the adjusting shaft to the at least one adjusting element,
wherein the at least one connecting element is coupled at a first end to the at least one adjusting element and at a second end to the adjusting shaft, more specifically in such a way that a rotary movement of the adjusting shaft around a longitudinal axis of the adjusting shaft is converted into an adjusting movement of the connecting element, which, in turn, leads to an adjusting movement of the adjusting element in the circumferential direction and thus to an adjustment of the stator vanes, and wherein the at least one connecting element is mounted in such a way as to be pivotable at its first end about a first pivoting axis and/or at its second end about a second pivoting axis,
wherein
at least one guiding device is provided, which specifies a guidance path along which the first pivoting axis can be displaced relative to the adjusting element or the second pivoting axis can be displaced relative to the adjusting shaft when the adjusting shaft is rotated.

2. The adjusting device according to claim 1, wherein
the first end of the at least one connecting element is guided along the guidance path in such a way by means of the at least one guiding device that, when the adjusting shaft is rotated, the first end is adjusted with a motion component radial to the central axis, or
the second end of the at least one connecting element is guided along the guidance path in such a way by means of the at least one guiding device that, when the adjusting shaft is rotated, the second end is adjusted with a motion component radial to the longitudinal axis of the adjusting shaft.

3. The adjusting device according to claim 1, wherein the first end of the at least one connecting element is coupled to the adjusting element by means of a connecting part, on which part of a slotted guide of the guiding device is provided for the purpose of specifying the guidance path.

4. The adjusting device according to claim 3, wherein the slotted guide comprises a guide slot and at least one guide element, which can be moved along the guide slot.

5. The adjusting device according to claim 4, wherein in that the guide slot is formed in the connecting part, and the guide element is provided on the first end of the at least one connecting element.

6. The adjusting device according to claim 1, wherein in that the second end of the at least one connecting element is coupled to the adjusting shaft by means of a coupling element connected to the adjusting shaft for conjoint rotation therewith, on which element part of a slotted guide of the guiding device is provided for the purpose of specifying the guidance path.

7. The adjusting device according to claim 6, wherein in that the slotted guide comprises at least one guide slot and at least one guide element, which can be moved along the guide slot.

8. The adjusting device according to claim 7, wherein in that the slotted guide comprises two at least partially overlapping guide slots and at least one guide element, which can be moved along both guide slots.

9. The adjusting device according to claim 7, wherein in that the slotted guide comprises a guide slot in the coupling element and at least one guide element, movable along the guide slot, on the second end of the at least one connecting element.

10. The adjusting device according to claim 8, wherein in that the adjusting shaft is rotatable relative to a guiding part of the guiding device in which a further guide slot is provided, which at least partially overlaps the guide slot of the coupling element, and the guide element of the second end is movable along the guide slot of the coupling element and along the guide slot of the guiding part.

11. The adjusting device according to claim 10, wherein in that the guide slot of the guiding part is formed in a section of the guiding part which extends radially outwards in relation to the longitudinal axis of the adjusting shaft.

12. The adjusting device according to claim 10, wherein at least two adjusting elements for stator vanes of two different stator vane rows are provided and are each coupled to an associated connecting element for transferring an adjusting force from the adjusting shaft to the respective associated adjusting element.

13. The adjusting device according to claim 12, wherein at least two guiding parts having guide slots that differ from one another are provided, each guiding part being assigned to one of the at least two connecting elements.

14. The adjusting device according to claim 4, wherein the guide slot has at least one arched or curved profile, at least in one section.

15. The adjusting device according to claim 1, wherein the guiding device, by means of which the second pivoting axis of the at least one connecting element can be displaced relative to the adjusting shaft, comprises a guide element which is connected to the second end of the at least one connecting element and which is taken along by rotation of the adjusting shaft around the longitudinal axis and, at the same time, guided along a control contour.

16. The adjusting device according to claim 15, wherein the control contour has sections at different radial distances from the longitudinal axis of the adjusting shaft, thus enabling the guide element to be displaced radially in relation to the longitudinal axis by being guided along these sections of the control contour.

17. The adjusting device according to claim 15, wherein the control contour is formed on a control element, relative to which the adjusting shaft is rotatably mounted.

18. The adjusting device according to claim 15, wherein the guide element is elastically preloaded against the control contour by means of at least one spring element.

19. The adjusting device according to claim 15, wherein the guide element is mounted movably in a connector component, which is connected to the adjusting shaft for conjoint rotation therewith.

20. The adjusting device according to claim 18, wherein the second end of the at least one connecting element is connected to a bearing element, and the at least one spring element is supported on the bearing element, on the one hand, and on the connector component, on the other hand.

21. The adjusting device according to claim 20, wherein the bearing element has an accommodation space, in which the at least one spring element and at least one part of the guide element and/or of the connector component are accommodated.

22. An engine having at least one adjusting device according to claim 1.
